(19) United States
(12) Patent Application Publication
(10) Pub. No.: US 2024/0116518 A1
(43) Pub. Date: Apr. 11, 2024

(54) SYSTEM AND METHOD OF ESTIMATING VEHICLE SPEED

(71) Applicant: Faraday&Future Inc., Gardena, CA (US)

(72) Inventors: Saleh Ziaieinejad, Irvine, CA (US); Geng Niu, Irvine, CA (US)

(21) Appl. No.: 18/376,786

(22) Filed: Oct. 4, 2023

Related U.S. Application Data
(60) Provisional application No. 63/413,152, filed on Oct. 4, 2022.

(51) Int. Cl. B60W 40/105; B60W 40/076; G01P 3/50

(52) U.S. Cl. CPC B60W 40/105; B60W 40/076; G01P 3/50; B60W 2520/105; B60W 2520/28

(57) ABSTRACT

A method to estimate the longitudinal vehicle speed is disclosed. The method is digitally implemented to process speeds of all wheels and longitudinal acceleration of the vehicle to estimate the vehicle speed.

### CROSS-REFERENCE

This application claims the priority of provisional application No. 63/413,152, filed on Oct. 4, 2022, the content of which is incorporated by reference herein in its entirety for all purposes.

### FIELD

This generally relates to a method of estimating vehicle speed and, in particular, to a method of estimating vehicle speed using measured variables of vehicle dynamics and inertial measurement unit.

### BACKGROUND

In normal driving conditions with good traction, vehicle speed can be estimated by (a) processing the rotating wheel speed(s) and considering the dimension(s) of the wheel(s); and/or (b) processing the rotating speed(s) of traction motor(s) and considering the gear ratio(s) and dimension(s) of the wheels. With poor traction, however, estimation of vehicle speed is very challenging. Whenever a vehicle drives on low-traction surfaces and/or the vehicle applies large torque to the wheels, one or multiple (possibly all) wheels will lose traction and could rotate freely (wheel slip). In this case, the speed of motor(s) or wheel(s) may not represent the vehicle speed. To better estimate the vehicle speed in two-wheel-drive vehicles, commonly speed of non-driven wheels is used. All-wheel-drive vehicles, however, do not have non-driven wheels and speed estimation during wheel slip is challenging.

Relevant prior art includes: (1) ALCANTAR, J. V., Torres, J. J., Barrette, P. J., Bruns, R. D., Stout, C. and Johri, R., Ford Global Technologies LLC, 2020 and (2) Estimation of vehicle speed in all-wheel-drive vehicle. U.S. Patent Application Pub. No. US 2020/0108816 A1. The published patent uses wheel speeds, longitudinal acceleration, and Electronic Stability Program (“ESP”) signals to estimate the vehicle speed. Its heavy reliance on ESP signals means that Powertrain Controller Electronic Control Unit (ECU) depends on algorithms running in an external ECU, the ESP, to estimate the speed and cannot estimate it independently. This is not optimal.

### SUMMARY

Embodiments of this disclosure relate to a method of estimating vehicle speed using measured variables of vehicle dynamics and inertial measurement unit (“IMU”). According to an embodiment, a method to estimate the longitudinal vehicle speed is disclosed. The method can be digitally implemented to process speeds of all wheels and longitudinal acceleration of the vehicle to estimate the vehicle speed. This method can be used in all vehicles regardless of their powertrain architecture (e.g., internal combustion engine vehicles, hybrid or plugin hybrid vehicles, electric vehicles, or fuel-cell vehicles).

Since vehicle speed is used in multiple safety-critical functions, it is preferred to have it independently estimated by only one ECU (Powertrain Controller).

### BRIEF DESCRIPTION OF THE DRAWINGS

FIG. 1 illustrates the exemplary modules of a system, according to an embodiment of the disclosure.

FIG. 2a shows the exemplary operations of the first subsystem 102, according to an embodiment of the disclosure.

FIG. 2b illustrates the exemplary modules of the first subsystem 200, according to an embodiment of the disclosure.

FIG. 3a shows the exemplary operations of the second subsystem, according to an embodiment of the disclosure.

FIG. 3b illustrates the exemplary modules of the second subsystem, according to an embodiment of the disclosure.

FIG. 4a shows the exemplary operations of the third subsystem, according to an embodiment of the disclosure.

FIG. 4b illustrates the exemplary modules of the third subsystem, according to an embodiment of the disclosure.

FIG. 5a shows the exemplary operations of the fourth subsystem, according to an embodiment of the disclosure.

FIG. 5b illustrates the exemplary modules of the fourth subsystem, according to an embodiment of the disclosure.

### DETAILED DESCRIPTION OF THE PREFERRED EMBODIMENTS

In the following description of preferred embodiments, reference is made to the accompanying drawings which form a part hereof, and in which it is shown by way of illustration specific embodiments, which can be practiced. It is to be understood that other embodiments can be used and structural changes can be made without departing from the scope of the embodiments of this disclosure.

Modern vehicles with advanced stability and control systems may be equipped with an IMU, which reports instantaneous acceleration in different directions including longitudinal acceleration. Embodiments of the disclosure use this signal to estimate the vehicle speed.

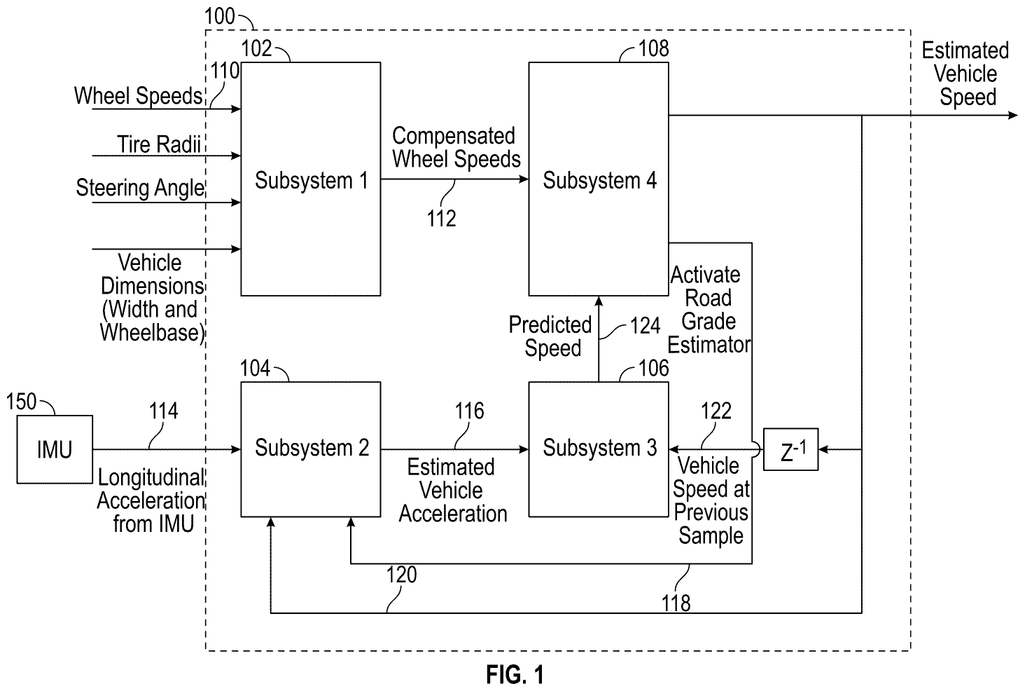

FIG. 1 illustrates the exemplary modules of a system, according to an embodiment of the disclosure. The system 100 of FIG. 1 includes 4 subsystems 102, 104, 106, 108. The first subsystem 102 processes wheel speeds 110 and outputs compensated wheel speeds 112. Assume ideal traction, when the vehicle moves in a straight line, linear speed of each wheel equals the longitudinal vehicle speed. However, when the vehicle is turning, none of the wheel speeds can accurately represent the longitudinal vehicle speeds. The first subsystem 102 finds gain factors to be multiplied by the rotating wheel speeds 110 such that each rotating wheel speed equals the longitudinal vehicle speed. In this embodiment, we consider the following two assumptions:

First, for simplicity, longitudinal vehicle speed is calculated for the point at the middle of the assumptive line connecting the centers of the rear wheels of the vehicle. This method could be modified to consider other points including the center of gravity of the vehicle. Second, for simplicity, instead of considering exact angles of left and right front wheels, the average of the two is considered.

### First Subsystem

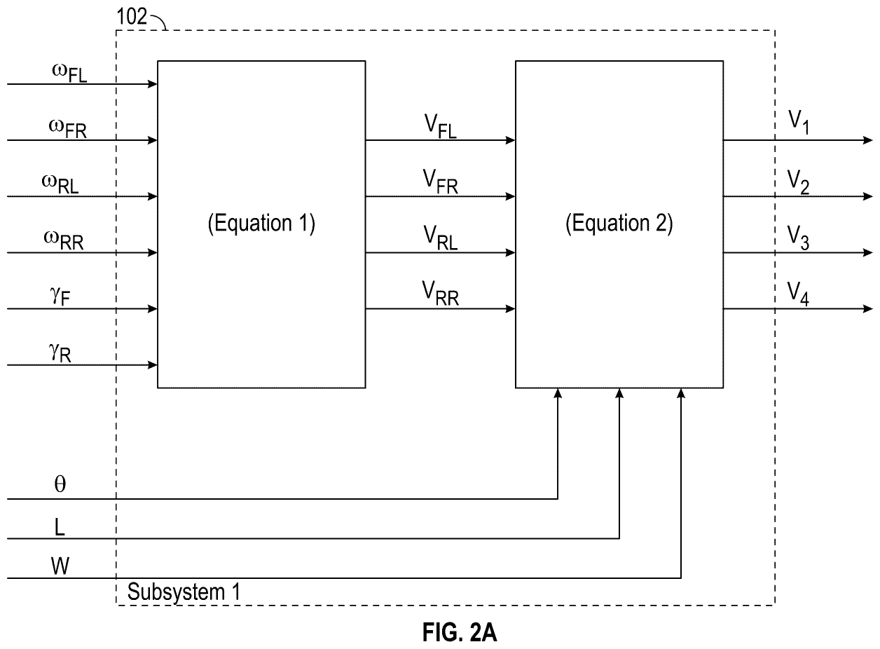

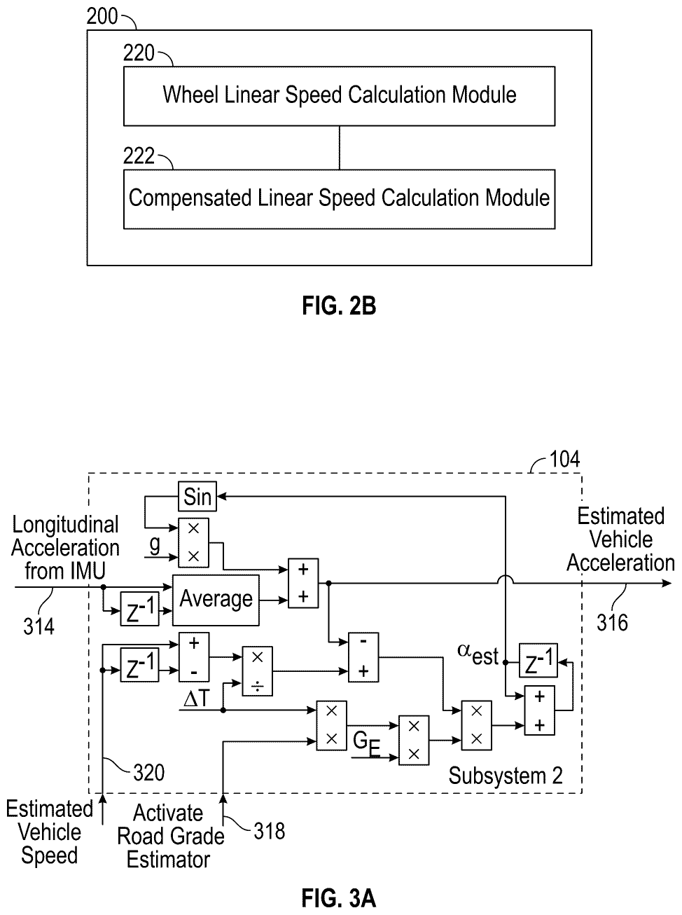

FIG. 2a shows the exemplary operations of the first subsystem 102, according to an embodiment of the disclosure. First, rotating wheel speeds are multiplied by tire radii to calculate linear speed of each wheel:

V_{FL}=r_{F}ω_{FL}

V_{FR}=r_{F}ω_{FR}

V_{RL}=r_{R}ω_{RL}

V_{RR}=r_{R}ω_{RR}. (Equation 1)

In this equation, ω [symbol] is the rotating speed of wheel i, V [symbol] is the linear speed of wheel i, r_{F} is the radius of front tires, and r_{R} is the radius of rear tires.

Based on Ackerman steering geometry and considering the abovementioned assumptions, compensated linear speed measured from each wheel can be calculated as:

$${V}_{1} ≃ \{ \begin{matrix}( 1 + \frac{W tan θ}{2 L} ) {V}_{RL} , & θ \geq 0 ( turning left ) ; \\ ( 1 + \frac{W tan θ}{2 L - 2 W tan θ} ) {V}_{RL} , & θ < 0 ( turning right )\end{matrix} . \qquad ( Equation 2 )$$

$${V}_{2} ≃ \{ \begin{matrix}( 1 - \frac{W tan θ}{2 L + 2 W tan θ} ) {V}_{RR} , & θ \geq 0 ( turning left ) ; \\ ( 1 - \frac{W tan θ}{2 L} ) {V}_{RR} , & θ < 0 ( turning right )\end{matrix} .$$

$${V}_{3} ≃ \{ \begin{matrix}( cos θ + \frac{W sin θ}{2 L} ) {V}_{FL} , & θ \geq 0 ( turning left ) ; \\ ( cos θ - \frac{W sin 2 θ}{4 L + 4 W sin θ} ) {V}_{FL} , & θ < 0 ( turning right )\end{matrix} .$$

$${V}_{4} ≃ \{ \begin{matrix}( cos θ + \frac{W sin 2 θ}{4 L - 4 W sin θ} ) {V}_{FR} , & θ \geq 0 ( turning left ) ; \\ ( cos θ - \frac{W sin θ}{2 L} ) {V}_{FR} , & θ < 0 ( turning right )\end{matrix} .$$

In Equation 2, θ is the average angle of the front right and front left wheels, W is the width of the vehicle, and L is the wheelbase of the vehicle. These equations change if the vehicle is equipped with rear steering system.

FIG. 2b illustrates the exemplary modules of the first subsystem 200, according to an embodiment of the disclosure. The first subsystem 200 can include a wheel linear speed calculation module 220 configured to receive the rotating wheel speed and tire radius of each wheel and calculate the linear speed of each wheel by multiplying the rotating wheel speeds by tire radii. The first subsystem can also include a compensated linear speed calculation module 222 configured to calculate a compensated linear speed measured from each wheel based on the average angle of the front right and front left wheels, the width of the vehicle, and the wheelbase of the vehicle.

### Second Subsystem

Referring back to FIG. 1, the second subsystem 104 receives the longitudinal acceleration 114 from the IMU 150, removes the gravity-induced acceleration term from it, and outputs the estimated vehicle acceleration 116. To calculate gravity-induced acceleration term, road grade can be estimated by comparing the estimated vehicle acceleration with the actual vehicle acceleration computed based on estimated vehicle speed. An activate road grade estimator signal 118 sent by the fourth subsystem 108 enables the estimator. Whenever the estimator is disabled, the second subsystem 104 can use the latest estimate of the road grade.

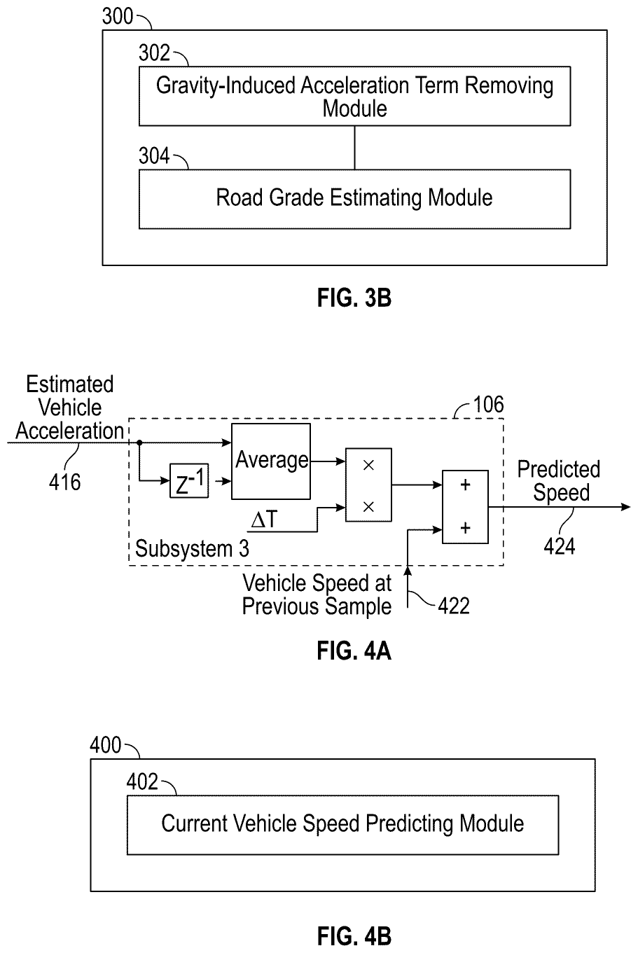

FIG. 3a shows the exemplary operations of the second subsystem 104 where g is the gravitational acceleration, αₑₛₜ is the estimated road grade, and ΔT is the sampling time of the system. The second subsystem 104 receives a longitudinal acceleration 314 from the IMU (not shown in FIG. 3a) and estimated vehicle speed 320 and activate road grade estimate 318 from the fourth subsystem (not shown in FIG. 3a). As illustrated in FIG. 3, the second subsystem 104 can perform the various operations (e.g., average, multiplication, summation, subtraction) on these received inputs and the gravitational acceleration, estimated road grade, and sampling time of the system to calculate an estimated vehicle acceleration 316.

FIG. 3b illustrates the exemplary modules of the second subsystem 300, according to an embodiment of the disclosure. The second subsystem 300 can include a gravity-induced acceleration term removing module 302 configured to remove the gravity-induced acceleration term from the longitudinal acceleration received from an IMU. The second subsystem 300 can further include road grade estimating module 304 configured to estimate the road grade by comparing the estimated vehicle acceleration with the actual vehicle acceleration computed based on estimated vehicle speed.

### Third Subsystem

The third subsystem 106 of system 100 of FIG. 1 uses the average acceleration since last step 116 (as estimated by the second subsystem 104) and the vehicle speed from previous sample 122 to predict the current vehicle speed 124. FIG. 4a illustrates the exemplary operations of the third subsystem 106 where ΔT is the sampling time of the system. The third subsystem 106 receives the estimated vehicle acceleration 416 and vehicle speed at previous sample 422 and performs the operations illustrated in FIG. 4a to calculate a predicted speed 424.

FIG. 4b illustrates the exemplary modules of the third subsystem 400, according to an embodiment of the disclosure. The third subsystem 400 can include a current vehicle speed predicting module 402 configured to predict the current vehicle speed based on the average acceleration since last step as estimated by the second subsystem and the vehicle speed in the last step.

### Fourth Subsystem

The fourth subsystem 108 of FIG. 1 evaluates the speed of each wheel and decides if it should be included in the final vehicle speed calculation. For validation, an acceptable range is defined for wheel speeds as [Predicted Vehicle Speed−ΔV₁, Predicted Vehicle Speed+ΔV₂], where ΔV₁ and ΔV₂ are design parameters. Any compensated wheel speed that is within this range is considered valid and is included in the final averaging function to find the vehicle speed. Any compensated wheel speed that is not within this range is considered invalid and is replaced with the predicted vehicle speed.

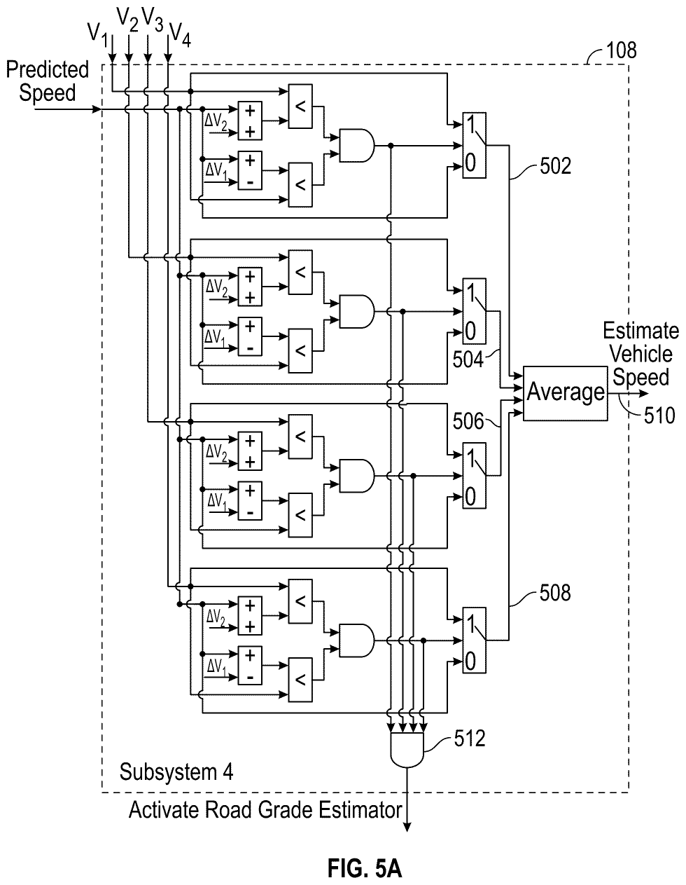

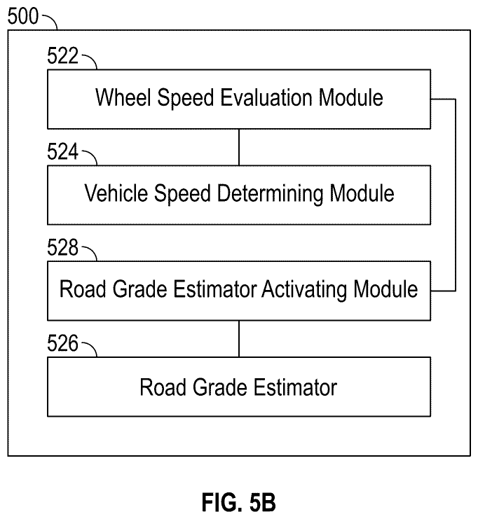

FIG. 5a illustrates the exemplary operations of the fourth subsystem 108. As illustrated in FIG. 5a, the fourth subsystem 108 can take the average of the final four values 502, 504, 506, 508 (each being either a compensated wheel speed or predicted vehicle speed) to estimate the vehicle speed 510. The fourth subsystem 108 can also decide whether the road grade estimator 512 should be activated using the exemplary operations illustrated in FIG. 5a. It can activate the estimator 512 if all compensated wheel speeds are valid.

FIG. 5b illustrates the exemplary modules of the fourth subsystem 500, according to an embodiment of the disclosure. The fourth subsystem 500 can include a wheel speed evaluation module 522 configured to determine whether the speed of each wheel should be included in the final vehicle speed calculation. The fourth subsystem 500 can also include a vehicle speed determining module 524 configured to determine the vehicle speed by averaging the valid compensated wheel speeds as determined by the wheel speed evaluation module 522. The fourth subsystem can also include a road grade estimated 526 and a road grade estimator activating module 528. The road grade estimator activating module 528 is configured to determine whether to activate road grade estimator 526 based on if all compensated wheel speeds are valid.

All of the methods and tasks described herein may be performed and fully automated by one or more computer systems. Each such computing system can include a processor (or multiple processors) that executes program instructions or modules stored in a memory or other non-transitory computer-readable storage medium or device (e.g., solid state storage devices, disk drives, etc.). The various functions disclosed herein may be embodied in such program instructions or may be implemented in application-specific circuitry (e.g., ASICs or FPGAs) of the computer system. Where the computer system includes multiple computing devices, these devices may, but need not, be co-located. The results of the disclosed methods and tasks may be persistently stored by transforming physical storage devices, such as solid-state memory chips or magnetic disks, into a different state. In some embodiments, the computer system may be a cloud-based computing system.

Depending on the embodiment, certain acts, events, or functions of any of the processes or algorithms described herein can be performed in a different sequence, can be added, merged, or left out altogether (e.g., not all described operations or events are necessary for the practice of the algorithm). Moreover, in certain embodiments, operations or events can be performed concurrently, e.g., through multi-threaded processing, interrupt processing, or multiple processors or processor cores or on other parallel architectures, rather than sequentially.

The elements of a method, process, routine, or algorithm described in connection with the embodiments disclosed herein can be embodied directly in hardware, in a software module executed by a processor device, or in a combination of the two. A software module can reside in RAM memory, flash memory, ROM memory, EPROM memory, EEPROM memory, registers, hard disk, a removable disk, or any other form of a non-transitory computer-readable storage medium. An exemplary storage medium can be coupled to the processor device such that the processor device can read information from, and write information to, the storage medium. In the alternative, the storage medium can be integral to the processor device. The processor device and the storage medium can reside in an ASIC.

Although embodiments of this disclosure have been fully described with reference to the accompanying drawings, it is to be noted that various changes and modifications will become apparent to those skilled in the art. Such changes and modifications are to be understood as being included within the scope of embodiments of this disclosure as defined by the appended claims.

What is claimed is:

1. A system for estimating a speed of a vehicle comprising a plurality of wheels, the system comprising:
a first subsystem configured to receive a steering angle, dimensions of the vehicle, wheel speeds and tire radii of the plurality of wheels and determine compensated wheel speeds of the plurality of wheels;
a second subsystem configured to receive longitudinal acceleration from an inertial measurement unit of the vehicle, remove gravity-induced acceleration term from the longitudinal acceleration, and output an estimated vehicle acceleration;
a third subsystem in communication with the second subsystem and configured to receive the estimated vehicle acceleration from the second subsystem, the third subsystem further configured to predict a current speed of the vehicle based on the estimated vehicle acceleration and a previous vehicle speed; and
a fourth subsystem in communication with the first subsystem, the second subsystem, and the third subsystem, the fourth subsystem configured to estimate the speed of the vehicle based on either the compensated wheel speeds or the predicted vehicle speed.

2. The system of claim 1, wherein the first subsystem is configured to determine compensated wheel speeds of the plurality of wheels by multiplying a rotating speed of each of the plurality of wheels by the tire radius of the wheel to calculate a linear speed of each wheel and determining the compensated wheel speeds based on the linear speeds of the plurality of wheels, an average angle of two of the plurality of wheels, a width of the vehicle, and a wheelbase of the vehicle.

3. The system of claim 1, wherein the second subsystem is further configured to calculate a gravity-induced acceleration term.

4. The system of claim 3, wherein the second subsystem is further configured to estimate a road grade by comparing the estimated vehicle acceleration with an actual vehicle acceleration computed based on the estimated speed of the vehicle.

5. The system of claim 4, wherein the second subsystem is further configured to estimate the road grade in response to receiving an activate road grade estimator signal from the fourth subsystem.

6. The system of claim 5, wherein the second subsystem is further configured to use a previous estimate of the road grade as the estimated road grade if no activate road grade estimator signal is received.

7. The system of claim 1, wherein the fourth subsystem is further configured to evaluate the compensated speed of each wheel and determine if the compensated speed should be used in calculating the speed of the vehicle.

8. The system of claim 7, wherein the compensated wheel speed of a wheel is used in calculating the speed of the vehicle if the compensated wheel speed is within a range; and wherein the predicted current speed of the vehicle replaces the compensated wheel speed in calculating the speed of the vehicle if the compensated wheel speed of a wheel is outside of the range.

9. The system of claim 7, wherein the fourth subsystem is further configured to determine whether to send an activate road grade estimator signal to the second subsystem.

10. A method of estimating a speed of a vehicle comprising a plurality of wheels, the method comprising:
obtaining a steering angle, dimensions of the vehicle, wheel speeds and tire radii of the plurality of wheels;
determining compensated wheel speeds of the plurality of wheels based on the steering angle, dimensions of the vehicle, and the wheel speeds and tire radii of the plurality of wheels;
receiving longitudinal acceleration from an inertial measurement unit of the vehicle;
outputting an estimated vehicle acceleration based on the longitudinal acceleration;
predicting a current speed of the vehicle based on the estimated vehicle acceleration and a previous vehicle speed; and
estimating the speed of the vehicle based on either the compensated wheel speeds or the predicted current speed of the vehicle.

11. The method of claim 10, further comprising removing gravity-induced acceleration term from the longitudinal acceleration prior to outputting the estimated vehicle acceleration;

12. The method of claim 10, wherein determining the compensated wheel speeds of the plurality of wheels comprising multiplying a rotating speed of each of the plurality of wheels by the tire radius of the wheel to calculate a linear speed of each wheel and determining the compensated wheel speeds based on the linear speeds of the plurality of wheels, an average angle of two of the plurality of wheels, a width of the vehicle, and a wheelbase of the vehicle.

13. The method of claim 10, further comprising calculating a gravity-induced acceleration term.

14. The method of claim 13, further comprising estimating a road grade by comparing the estimated vehicle acceleration with an actual vehicle acceleration computed based on the estimated speed of the vehicle.

15. The method of claim 14, wherein estimating the road grade is in response to receiving an activate road grade estimator signal.

16. The method of claim 15, further comprising using a previous estimate of the road grade as the estimated road grade if no activate road grade estimator signal is received.

17. The method of claim 10, further comprising evaluating the compensated speed of each wheel and determining if the compensated speed should be used in calculating the speed of the vehicle.

18. The method of claim 17, wherein the compensated wheel speed of a wheel is used in calculating the speed of the vehicle if the compensated wheel speed is within a range; and wherein the predicted current speed of the vehicle replaces the compensated wheel speed in calculating the speed of the vehicle if the compensated wheel speed of a wheel is outside of the range.

19. The method of claim 17, further comprising determining whether to send an activate road grade estimator signal.

20. A non-transitory computer-readable storage medium storing instructions for causing a processor to perform a method of estimating a speed of a vehicle comprising a plurality of wheels, the method comprising:
obtaining a steering angle, dimensions of the vehicle, wheel speeds and tire radii of the plurality of wheels;
determining compensated wheel speeds of the plurality of wheels based on the steering angle, dimensions of the vehicle, and the wheel speeds and tire radii of the plurality of wheels;
receiving longitudinal acceleration from an inertial measurement unit of the vehicle;
outputting an estimated vehicle acceleration based on the longitudinal acceleration;
predicting a current speed of the vehicle based on the estimated vehicle acceleration and a previous vehicle speed; and
estimating the speed of the vehicle based on either the compensated wheel speeds or the predicted current speed of the vehicle.
